(19) United States
(12) Patent Application Publication
(10) Pub. No.: US 2002/0106493 A1
(43) Pub. Date: Aug. 8, 2002

(54) Transfer sheet for nail decoration

(76) Inventors: Yoshihiro Komuta, Moriguchi-shi (JP); Mitsushi Wada, Toyonaka-shi (JP)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/910,294

(22) Filed: Jul. 20, 2001

(30) Foreign Application Priority Data
Feb. 7, 2001 (JP) 2001-30504
Feb. 7, 2001 (JP) 2001-2675

(51) Int. Cl. B32B 27/14

(52) U.S. Cl. 428/195; 428/41.8

(57) ABSTRACT

A transfer sheet for nail decoration is provided which can be easily and rapidly applied, and which produces almost no discomfort when worn. The transfer sheet includes a transfer layer having an adhesive layer laminated to an ink layer, and a substrate sheet which is applied to the surface on the side opposite the adhesion surface of the transfer layer. The transfer layer can be applied to a nail by pressing the transfer sheet to the nail such that the adhesive surface of the transfer layer adheres to the nail. Once the transfer layer has been adhered to the nail, the substrate sheet is separated, and the transfer layer that projects beyond the nail is severed to match the shape of the nail. The transfer layer can also be neatly severed in the shape of the nail simply by tearing it off along the edge of the nail.

### CROSS-REFERENCE TO RELATED APPLICATIONS

This application claims priority from Japanese Patent Application Serial No. 2001-30504, filed on Feb. 7, 2001 and Japanese Design Application Serial No. 2001-2675, filed Feb. 7, 2001.

### FIELD OF THE INVENTION

The present invention relates to a transfer sheet for nail decoration whereby a nail is decorated by transferring ink onto the surface of the nail.

### BACKGROUND OF THE INVENTION

Conventionally, nail art has been enjoyed wherein nails are groomed, and fingertips are made to look fashionable by means of false nails and manicures. As the number of nail artists and nail salons has increased in recent years, this has become particularly fashionable amongst young women in urban centers. However, when this nail art is applied in nail salons, even at those having relatively affordable prices, the cost may be higher than desirable to some users.

Nail stickers, which are applied to the surface of the nail, have been made available as one means for allowing users to apply nail art on their own. These nail stickers typically include an adhesive sticker provided on a substrate sheet made of fabric or resin, on which a pattern has been printed. The nail sticker is cut using scissors or a knife to match the shape of the nail onto which the nail sticker is to be applied. The separation film is then peeled off from the adhesive layer, and the nail sticker is applied to the surface of the nail.

However, these nail stickers can be undesirably difficult to use because they must be cut to match the shape of the nail onto which they are to be applied, usually using scissors or a knife. This operation can be difficult and time consuming, and if a mistake is made in cutting the sheet will project from the nail or the nail will not be completely covered. Furthermore, because prior nail stickers generally use a substrate sheet made of fabric or resin that is glued to the nail with an adhesive, they undesirably increase the thickness of the nail and may be uncomfortable when worn.

The present invention is a reflection of these facts, and therefore, an object thereof is to provide a transfer sheet for nail decoration which can be applied quickly and easily, and wherein there is almost no discomfort in wearing it.

### SUMMARY OF THE INVENTION

In order to achieve the aforementioned objective, an improved transfer sheet for nail decoration is provided. The transfer sheet of the present invention includes a transfer layer having an adhesive layer and at least one ink layer which are laminated together. A substrate sheet is separably applied to the surface of the transfer sheet opposite the adhesion surface of said transfer layer for allowing easy handling of the transfer layer.

More specifically, the transfer sheet for nail decoration of the present invention includes a transfer layer having an adhesive layer and ink layer which are laminated together, and a substrate sheet which is separably applied to the surface of the transfer sheet opposite the adhesion surface of said transfer layer. Consequently, the nail can be decorated, by pressing the transfer sheet so that the adhesive surface of the transfer layer adheres to, and is applied to, the nail. When the transfer layer has been applied to the nail, the substrate sheet is separated, and the transfer layer that projects from the nail is severed so as to match the shape of the nail, both covering and decorating the nail.

Because only the adhesive layer and the one or more ink layers that are laminated together in the transfer layer are applied to the nail, the transfer layer can easily be severed to match the shape of the nail by simply by tearing the transfer layer off along the edge of the nail. Thus, as compared to conventional nail stickers, the transfer layer of the present invention can be applied very easily and quickly. Furthermore, because only the ink and adhesive layers of the transfer layer are applied to the surface of the nail, the thickness of the nail is not increased undesirably as would be the case with conventional stickers wherein a substrate sheet was glued to the nail. Accordingly, as compared to conventional nail stickers, there is almost no discomfort when the nail decorations of the present invention are worn.

A separable protective sheet may optionally be included to protect the adhesive of the transfer sheet for nail decoration of the present invention from becoming dirty or soiled prior to use. The separable protective sheet serves both to prevent dust from sticking to the adhesive and thereby weakening the adhesive strength, and to prevent marring of the aesthetic features of the nail decoration by dirt or stain.

The transfer sheet for nail decoration of the present invention can also optionally include a nail application piece formed in a substantially arched shape roughly corresponding to a cuticle. In general, the leading edge of the nail application piece is formed in a substantially arched shape along the cuticle, allowing the difficult to cut cuticle area to closely match the shape of the nail. Furthermore, in cases where this nail application piece is formed with a width approximately equal to that of the nail, the edge at the extremity of the nail is the only portion which has to be severed to match the nail. Therefore, the nail can be covered very easily, simply by tearing off the transfer layer along the edge of the nail.

The transfer sheet for nail decoration of the present invention can optionally be provided with a plurality, nail application pieces that are joined together at the end opposite the leading edge. More preferably, at least five nail application pieces are provided including one for the thumb, one for the index finger, one for the middle finger, one for the ring finger, and one for the little finger. This facilitates the easy decoration of the nails of the five respective fingers by transferring the transfer layer to the nails of all the fingers. Optionally, a plurality of spare nail application pieces can also be provided having different widths for use in accordance with the size of the hand and the thickness of the finger.

### BRIEF DESCRIPTION OF THE DRAWINGS

FIG. 1 illustrates a sectional view showing a first exemplary embodiment of a transfer sheet for nail decoration in accordance with the present invention.

FIG. 2 illustrates a plane view of a transfer sheet for nail decoration in accordance with the embodiment of FIG. 1.

FIG. 3 is an explanatory diagram illustrating the usage of the transfer sheet of FIG. 1 for nail decoration.

FIG. 4 is another explanatory diagram illustrating the usage of the transfer sheet of FIG. 1 for nail decoration.

FIG. 5 is yet another explanatory diagram illustrating the usage of the transfer sheet of FIG. 1 for nail decoration.

FIG. 6 is yet another explanatory diagram illustrating the usage of the transfer sheet of FIG. 1 for nail decoration.

FIG. 7 is yet another explanatory diagram illustrating the usage of the transfer sheet of FIG. 1 for nail decoration.

FIG. 8 illustrates a plane view of a second exemplary embodiment of a transfer sheet for nail decoration in accordance with the present invention.

FIG. 9 illustrates a plane view of a third exemplary embodiment of a transfer sheet for nail decoration in accordance with the present invention.

FIG. 10 illustrates a plane view of a fourth exemplary embodiment of a transfer sheet for nail decoration in accordance with the present invention.

### DETAILED DESCRIPTION OF AN EXEMPLARY EMBODIMENT

The following exemplary embodiments describe the vascular filtration device and method of the present invention and are provided for exemplary purposes and are not meant as limiting the invention.

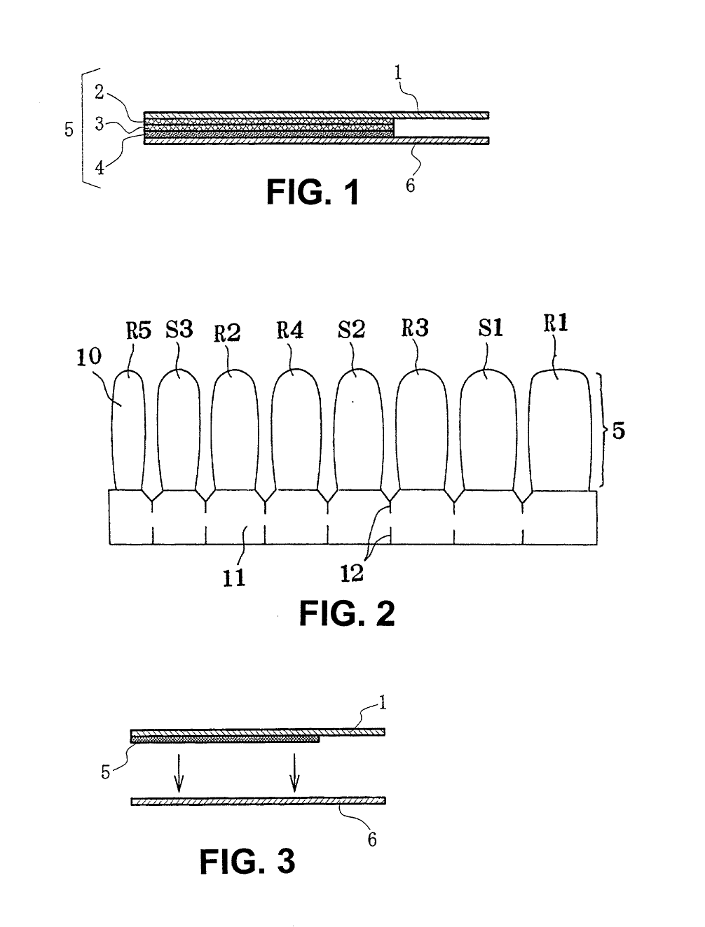

Referring now to the drawings in which the numerals represent like components or steps throughout the several views, FIG. 1 displays a first exemplary embodiment of a transfer sheet for nail decoration in accordance with the present invention. The transfer sheet for nail decoration includes a substrate sheet 1, a transfer layer 5, and a separation film 6 which are laminated together.

In the first exemplary embodiment, a resin film comprising a PET resin etc. is used as the substrate sheet 1. A transparent resin is used for this substrate sheet 1, so that the pattern and coloring of the transfer layer 5 can easily be recognized and positioned by the user.

The transfer layer 5 preferably includes and at least a first ink layer 2, and preferably a second ink layer 3, and an adhesive layer 4 which are laminated together. In the first exemplary embodiment, the transfer layer 5 is constructed such that the side opposite the adhesive surface (that is to say adjacent the first ink layer 2 or second ink layer 3) is separably affixed to the substrate sheet 1. The second ink layer 3 forms the background color of the transfer layer 5, and the first ink layer 2 forms various patterns against a background of this color.

Screen-printing ink is suitable for use in the inks that form the first and second ink layers 2 and 3. These include, for example, radical polymerization or cationic polymerization type UV setting inks wherein the primary components are monofunctional/polyfunctional oligomers and monofunctional/polyfunctional acrylic ester monomers.

There are no particular restrictions on the adhesive which forms the adhesive layer 4; various types of substances can be used, and any type of adhesive which adheres to skin, nails, etc. and which has little effect on the human body is suitable for use.

The adhesive surface of the transfer layer 5 which is affixed to the substrate sheet 1 is covered by the separable protective film 6. Separable protective film 6 protects the adhesive surface from becoming dirty or soiled and serves to prevent dust from sticking to, and thereby weakening the adhesive.

As shown in FIG. 2, the transfer sheet for nail decoration is provided with nail application pieces formed in a substantially arched shape which roughly corresponds to a cuticle at one end thereof. In the illustrated example, eight of these nail application pieces 10 are provided in a horizontal row, and each of the nail application pieces 10 are attached to an attachment piece 11 at the base thereof.

The transfer layer 5 is provided at the section corresponding to the nail application pieces 10, but the transfer layer 5 is not provided at the section corresponding to the connecting piece 11. A scoring 12 can also optionally be provided in the section between nail application pieces 10, on the connecting piece 11, so that the nail application pieces 10 can easily be tom off one-by-one as needed.

Nail application pieces 10 preferably include at least 5 nail application pieces, R1. R2, R3, R4, and R5: including one each for the thumb (R1), the index finger (R2), the middle finger (R3), the ring finger (R4), and little finger (R5). Nail application pieces 10 and R1-R5 are formed so that the shape that forms an arch at the end, the lateral measurements, and the slight curving on both sides are suited to their respective fingers. Thus, by using respective nail application pieces 10 which match the nails of the five fingers, transfer layer 5 can easily be transferred to the nails of all the fingers, and decoration can be performed easily.

Nail application pieces 10 can also include a plurality of spare nail application pieces S1, S2, and S3. Spare nail application pieces S1, S2, and S3 are preferably formed so that the lateral dimensions, the slight curving on both sides, and the shape of the arch at the end differ from each other. Thus, any of the spare nail application pieces 10 may be used as needed to match the size of the hand and the thickness of a desired finger.

A transfer sheet for nail decoration having the aforementioned construction can, for example, be used in the following manner. First, as shown in FIG. 3, the separation film 6 is peeled off from the adhesive surface of the transfer layer 5. Hereinafter, as well as in this drawing, transfer layer 5 is represented as if it were a single layer. However, as previsously discussed, transfer layer 5 actually has a multi-layer layer constitution, preferably including at least a first ink layer 2, a second ink layer 3, and an adhesive layer 4.

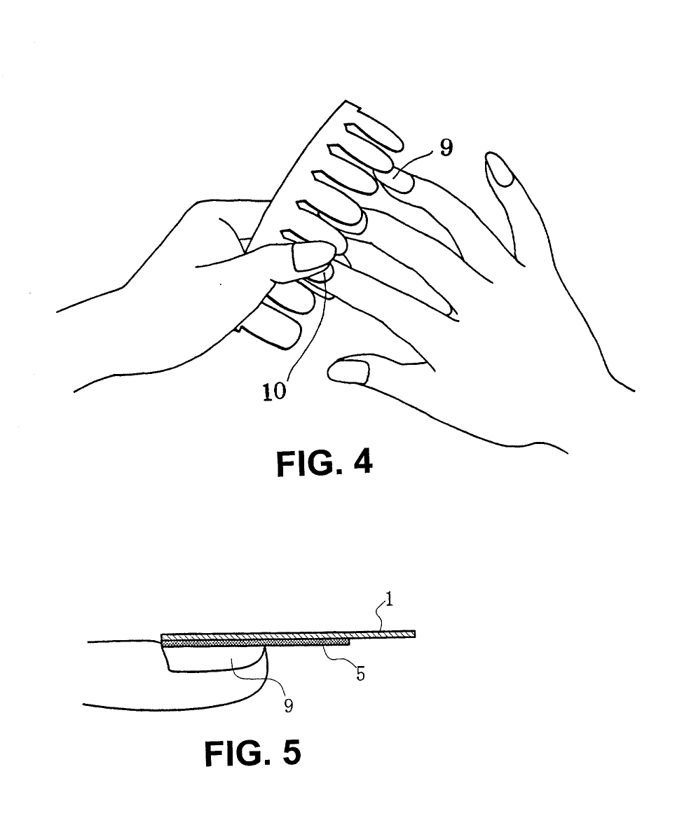

Next, as shown in FIGS. 4 and 5, the arched shaped portion at the end of the nail application pieces 10 is positioned to match the edge of the cuticle. The adhesive surface is caused to adhere to the surface of the nail 9 by pressing on the top of the substrate sheet 1, and transfer layer 5 is, thus, transferred from the substrate sheet 1 to the surface of the nail 9. By performing the transfer so that the edge that is formed in a substantially arched shape is in line with the cuticle, the cuticle shape, which is the most difficult to cut to match the shape of the nail 9, can easily be matched to the nail 9.

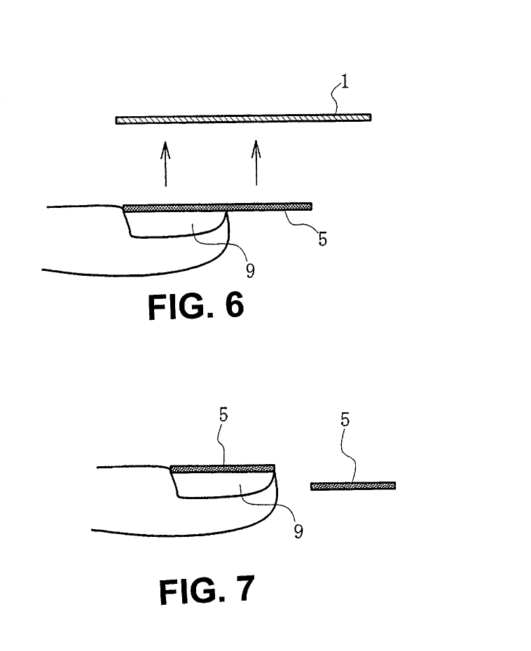

Next, after the substrate sheet 1 is peeled off from the transfer layer 5 which has been transferred to the nail 9, as shown in FIG. 6, excess transfer layer 5 at the end of the nail 9 may be simply torn off so as to match the shape of the end of the nail 9. As shown in FIG. 7, the entire nail 9 is neatly covered by this process, thus, decorating it. Furthermore, at this time, because the nail application pieces 10 are formed at approximately the same widths as the nails 9, only the portion at the extremity of the nail 9 need be severed so as to match the nail 9. Thus, the nail 9 can be covered very easily, simply by tearing off the transfer layer 5 along the edge of the nail 9.

With a transfer sheet for nail decoration of this sort, because the transfer layer 5 is a laminate of the adhesive layer 4 and the ink layers 2 and 3, it is possible to sever transfer layer 5 to neatly match the shape of the nail simply by tearing it along the edge of nail 9. Thus, as compared with conventional nail stickers, the transfer layer 5 of the present invention can be applied very easily and quickly. Furthermore, because only the transfer layer 5, comprising the laminate of the adhesive layer 4 and the ink layers 2 and 3, is applied to the surface of the nail 9, the resulting transfer layer is very thin, as compared with conventional stickers wherein a substrate sheet is glued to the nail. Accordingly, as compared to conventional nail stickers, there is almost no discomfort when wearing it.

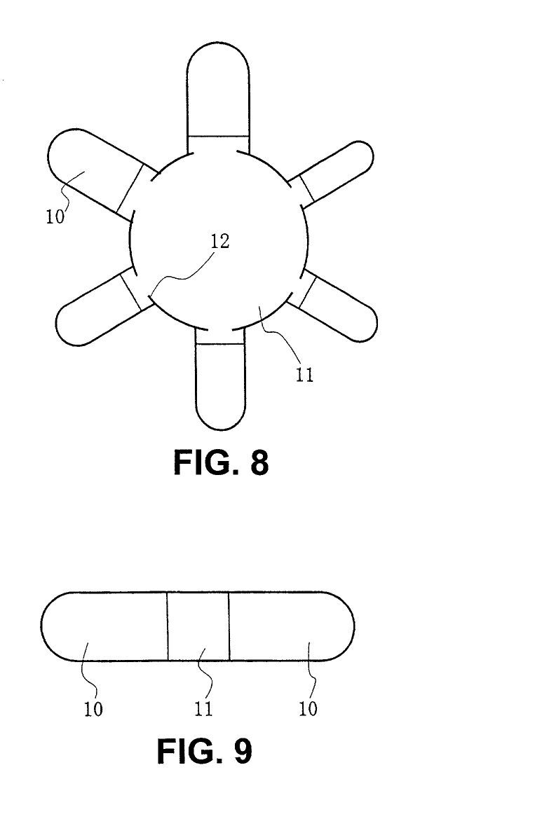

FIG. 8 shows a second exemplary embodiment of the transfer sheet for nail decoration of the present invention. In the second exemplary embodiment, five nail application pieces 10 are positioned on a circular connecting piece 11. With the exception of this circular connecting piece, the second exemplary embodiment is essentially the same as the aforementioned first exemplary embodiment

FIG. 9 shows a third exemplary embodiment of the transfer sheet for nail decoration of the present invention. In the third exemplary embodiment, two nail application pieces 10 are connected to either end of a connecting piece 11. By such means, the sheet can be supplied in separate packages for each finger, rather than in a 5-finger set. With the exception of this, the third exemplary embodiment is essentially the same as the aforementioned first exemplary embodiment, and has the same beneficial effects when used.

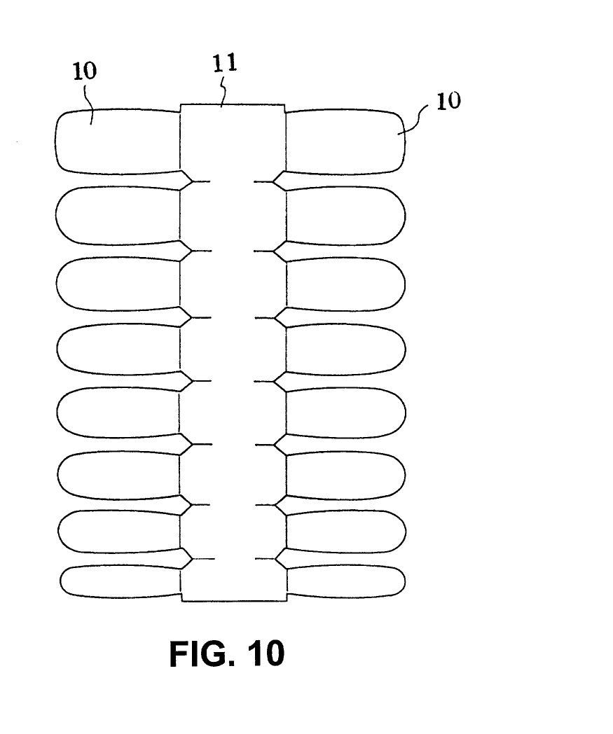

FIG. 10 that shows a fourth exemplary embodiment of the transfer sheet for nail decoration of the present invention. In the fourth exemplary embodiment, sixteen nail application pieces 10 are positioned on a connecting piece 11. With the exception of this, the fourth exemplary embodiment is essentially the same as the aforementioned first exemplary embodiment, and has the same beneficial effects when used.

In the embodiments described above, exemplary embodiments have been provided wherein the transfer layer 5 has a three-layer constitution, comprising a first ink layer 2, a second ink layer 3, and an adhesive layer 4. However, one of ordinary skill in the art should recognize that the transfer layer may also easily have a two-layer structure or a structure having four or more layers, so long as the transfer layer 5 includes at least an adhesive layer 4 and a first ink layer. Furthermore, transfer layer 5 can also optionally include structures wherein other layers are present, in addition to the ink layers and the adhesive layer 4.

In the embodiments described above, examples were given wherein the transfer layer 5 was transferred to the nail 9 with the nail application pieces 10 still interconnected. However, one of ordinary skill in the art will recognize that the transfer layer 5 can be transferred to the nail 9 after tearing off individual nail application pieces 10 from the connecting piece 11 along the scoring 12. Furthermore, in the embodiments described above, examples have been provided wherein the transfer layer 5 was transferred to the nails 9 of fingers, so as to decorate them. However, the transfer layer 5 can also obviously be transferred to toenails as well so as to decorate them.

The transfer sheet of the present invention can be used to transfer the transfer layer 5 directly onto a nail 9. However, it is also possible to transfer layer 5 onto manicure or pedicure coatings that have already been applied to the surface of the nail 9, so as to decorate them. These coatings may include, but are not limited to, conventional nail paints, colorings and polishes.

The above described transfer sheet for decorating nails may generally be used to apply decorative designs to nails according to the following method. First, the transfer layer is applied to the nail by pressing the transfer sheet so that the adhesive surface of the transfer layer is caused to adhere to the nail. When the transfer layer has been applied to the nail, the substrate sheet is separated from the nail, and the transfer layer that projects from the nail is severed so as to match the shape of the nail. This precisely covers the surface of the nail with the transfer layer, thus decorating it. Since the transfer layer includes an adhesive layer and at least one ink layer that are laminated rather than a sticker substrate layer, the transfer layer can be severed so as to neatly match the shape of the nail, simply by tearing it off along the edge of the nail. Thus, as compared to conventional nail stickers, the transfer layer of the present invention can be applied very easily and quickly. Furthermore, since only the ink and adhesive layers of the transfer layer are applied to the surface of the nail, the transfer layer is very thin as compared to conventional stickers wherein a substrate sheet is glued to the nail. Accordingly, as compared to conventional nail stickers, there is almost no discomfort when the transfer layer of the present invention is worn.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention, as determined by the appended claims when interpreted in accordance with the breadth to which they are fairly and legally entitled. Additionally, the many additional embodiments illustrated and described in the accompanying materials should be considered a part of the present invention.

What is claimed is:

1. A transfer sheet for nail decoration comprising:
a transfer layer including an adhesive layer and a first ink layer; and
a substrate sheet which is releasably adhered to said adhesion layer of said transfer layer.

2. The transfer sheet for nail decoration of claim 1, wherein said adhesion surface is covered with a separable protective sheet.

3. The transfer sheet for nail decoration of claim one or claim 2, wherein said transfer sheet for nail decoration comprises a nail application piece formed in a substantially arched shape roughly corresponding to the shape of a cuticle.

4. The transfer sheet for nail decoration of any one of claims 1, wherein said transfer sheet for nail decoration comprises a plurality of nail application pieces formed in substantially arched shapes roughly corresponding to cuticles at a first end thereof, and wherein said nail application pieces are connected at an opposing end thereof.

5. The transfer sheet for nail decoration of claim 4, wherein said plurality of nail application pieces include a first nail application piece corresponding to a thumb, a second nail application piece corresponding to an index finger, a third nail application piece corresponding to a middle finger, a fourth nail application piece corresponding to a ring finger, and a fifth nail application piece corresponding to a little finger.

6. The transfer sheet for nail decoration of claim 5, also comprising a spare nail application piece.

7. The transfer sheet for nail decoration of claim 5, wherein a plurality of pieces of differing widths are provided as said spare nail application pieces.

8. The transfer sheet for nail decoration of claim 1, wherein said transfer layer further includes a second ink layer.
